(19) United States
(12) Patent Application Publication
(10) Pub. No.: US 2016/0132786 A1
(43) Pub. Date: May 12, 2016

(54) PARTITIONING DATA FOR TRAINING MACHINE-LEARNING CLASSIFIERS

(71) Applicants: Alexandru Balan, Redmond, WA (US); Bradford Jason Snow, Duvall, WA (US); Christopher Douglas Edmonds, Carnation, WA (US); Henry Nelson Jerez, Sammamish, WA (US); Kyungsuk David Lee, Bellevue, WA (US); Mark J. Finocchio, Redmond, WA (US); Miguel Susffalich, Kirkland, WA (US); Cem Keskin, Cambridge (GB)

(72) Inventors: Alexandru Balan, Redmond, WA (US); Bradford Jason Snow, Duvall, WA (US); Christopher Douglas Edmonds, Carnation, WA (US); Henry Nelson Jerez, Sammamish, WA (US); Kyungsuk David Lee, Bellevue, WA (US); Mark J. Finocchio, Redmond, WA (US); Miguel Susffalich, Kirkland, WA (US); Cem Keskin, Cambridge (GB)

(21) Appl. No.: 14/539,778

(22) Filed: Nov. 12, 2014

(51) Int. Cl. G06N 99/00

(52) U.S. Cl. CPC G06N 99/005

(57) ABSTRACT

Various embodiments relating to partitioning a data set for training machine-learning classifiers based on an output of a globally trained machine-learning classifier are disclosed. In one embodiment, a first machine-learning classifier may be trained on a set of training data to produce a corresponding set of output data. The set of training data may be partitioned into a plurality of subsets based on the set of output data. Each subset may correspond to a different class. A second machine-learning classifier may be trained on the set of training data using a plurality of classes corresponding to the plurality of subsets to produce, for each data object of the set of training data, a probability distribution having for each class a probability that the data object is a member of the class.

### BACKGROUND

Machine-learning classifiers may receive a data object as input and return a probability that the data object is a member of a designated class (or classes). Machine-learning classifiers may be trained offline based on a large set of data (e.g., a ground truth) expected to be observed during run-time execution. Typically, a single classifier may be trained and used to classify data across numerous scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments relating to partitioning a set of data for training specific machine-learning classifiers based on an output of a globally trained machine-learning classifier are disclosed. In one embodiment, a first machine-learning classifier may be trained on a set of training data to produce a corresponding set of output data. The set of training data may be partitioned into a plurality of subsets based on the set of output data. Each subset may correspond to a different class. A second machine-learning classifier may be trained on the set of training data using a plurality of classes corresponding to the plurality of subsets to produce, for each data object of the set of training data, a probability distribution having for each class a probability that the data object is a member of the class.

### BRIEF DESCRIPTION OF THE DRAWINGS

FIG. 1 shows an example approach for partitioning a set of training data based on output data produced by a machine-learning classifier to train another machine classifier.

FIG. 2 shows an example approach for classifying real-world data using a hierarchy of machine-learning classifiers.

FIG. 3 shows an example hierarchy of machine-learning classifiers.

FIG. 4 shows an example hierarchy of machine-learning classifiers configured to classify images of different hand poses.

FIG. 5 shows an example scenario in which a hand-pose image is classified by the hierarchy of machine-learning classifiers shown in FIG. 4 as being a closed hand.

FIG. 6 shows an example scenario in which a hand-pose image is classified by the hierarchy of machine-learning classifiers shown in FIG. 4 as being a pointing hand.

FIG. 7 shows an example method for training machine-learning classifiers on a set of training data having learned partitions.

FIG. 8 shows an example method for classifying real-world data using a hierarchy of classifiers.

FIG. 9 shows an example computing system.

### DETAILED DESCRIPTION

As discussed above, a single machine-learning classifier may be trained and used to classify data across numerous scenarios. However, in some cases, a single machine-learning classifier may have difficulty generalizing all scenarios or may be unable to distinguish between two or more different classes when classifying a data object. In these cases, the machine-learning classifier may provide an inaccurate classification of the data being classified.

In some cases, a machine-learning classifier may have difficulty distinguishing between different classes, because a set of classes used by the machine-learning classifier may not fully capture a context of a problem space being classified. For example, a set of classes may be predetermined independently of a given ground truth used to train the machine-learning classifier. In other words, the set of classes may be determined in an a priori manner that does not depend on the data included in the ground truth. Because there is no direct link between the predetermined classes and the actual data used to train the machine-learning classifier, there may be data objects that do not match any particular class, and thus may be classified inaccurately.

The present disclosure relates to partitioning a set of training data used to train a machine-learning classifier in a learned manner that is dependent on a set of training data. More particularly, the present disclosure relates to partitioning a set of training data into a plurality of subsets based on output data produced by a first machine-learning classifier trained on the entire set of training data. The learned subsets may be associated with a plurality of classes, and a second machine-learning classifier may be trained on the set of training data using the plurality of classes. Accordingly, the second machine-learning classifier may be used to classify real-world data objects in a manner that may be more accurate relative to a machine-learning classifier that uses predetermined classes.

Furthermore, the present disclosure relates to training and using a hierarchy of machine-learning classifiers to classify data in a manner that may be more accurate across different scenarios relative to a single machine-learning classifier. The hierarchy of machine-learning classifiers may include a front-end machine-learning classifier chained together with additional specialized machine-learning classifiers. The front-end machine-learning classifier may be globally trained on an entire set of training data. In some implementations, the front-end machine-learning classifier may use learned classes corresponding to different subsets as discussed above. Further, each specialized or subset-specific machine-learning classifiers may be trained on a particular subset of the set of training data. For example, a subset-specific machine-learning classifier may be trained on a subset of data objects in the set of training data that resemble or otherwise correspond to a particular scenario in which the single classifier may be unable to distinguish between two or more classes.

In one example, when the front-end machine-learning classifier is run on a data object to be classified, resulting output data may indicate that the data object either belongs to a particular class or the front-end classifier is unable to distinguish between two or more classes. In cases where the front-end machine-learning classifier is confused between two or more classes, a subset-specific machine-learning classifier may be selected to be run on the data object in order to identify the class to which the data object belongs. In particular, the subset-specific machine-learning classifier may be selected, because the classifier is trained on a subset of data objects that resemble the data object being classified (e.g., ambiguous as being a member of two classes). In other words, the subset-specific machine-learning classifier may have more specialized training that provides a more accurate classification relative to the front-end machine-learning classifier for the particular scenario.

By organizing machine-learning classifiers that are trained to identify specific scenarios into a hierarchy, a data object to be classified may be directed to an appropriate machine-learning classifier that is trained to identify the particular scenario for the data object.

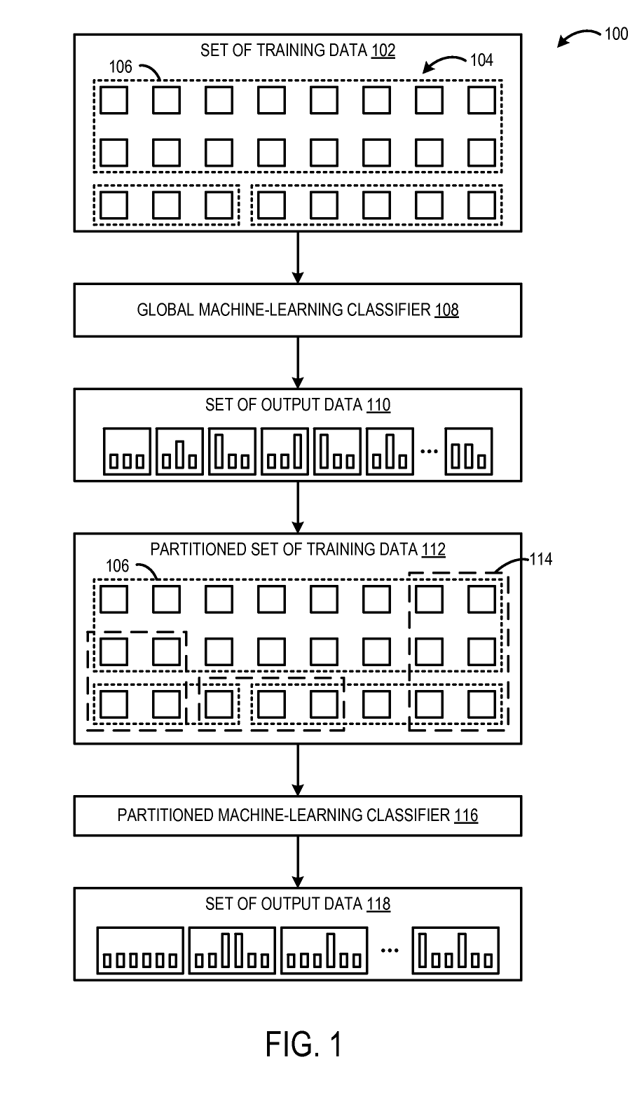

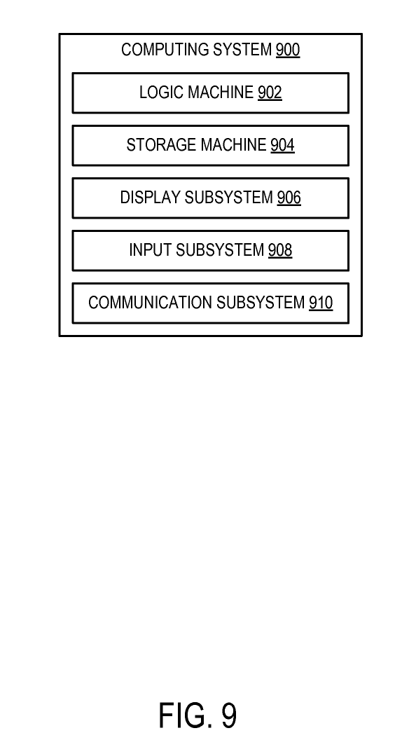

FIG. 1 shows an example approach 100 for training a machine-learning classifier based on a set of training data having learned portions based on output data produced by a machine-learning classifier. For example, the approach may be performed by a computing system, such as a computing system 900 shown in FIG. 9.

A set of training data (e.g., a ground truth) 102 may be used to train a global machine-learning classifier 108. The set of training data 102 includes a plurality of different data objects 104. The data objects may be any suitable type of data. Moreover, the plurality of data objects may be classified in any suitable manner. However, for the sake of simplicity, discussion will be limited to examples where the set of training data include image data objects (e.g., depth/IR/RGB pixels)—such as generated via motion-capture of observed humans or other objects that move and change position/orientation within a capture volume. For example, such image data objects may be classified for human body part recognition, pose estimation, object segmentation, or other suitable types of classification.

In some implementations, the set of training data 102 may be unlabeled prior to being used to train a machine-learning classifier. In other words, the data objects in the set of training data are not classified or assigned to any predetermined classes.

In other implementations, the set of training data 102 may be labeled prior to being used to train the first machine-learning classifier. In other words, the set of training data is classified into a plurality of subsets corresponding to a plurality of classes. In the illustrated example, the plurality of predetermined subsets are indicated by the dotted lines. As one example, a subset 106 includes a plurality of data objects of the set of training data 102 that are classified as belonging to a predetermined class.

The global machine-learning classifier 108 may take any suitable form. For example, the global machine-learning classifier 108 may be a decision tree, a random decision forest (RDF), support vector machine (SVM), a neural network, or another suitable type of classifier. The global machine-learning classifier 108 may be trained on the entire set of training data 102. The global machine-learning classifier 108 may produce a corresponding set of output data 110 that attempts to classify scenarios for all data objects in the set of training data. For example, the output data may include for each data object, a probability distribution that determines different probabilities for the data object. In some implementations, the output data 110 may include a histogram for each data object. The set of output data 110 may take any suitable form without departing from the scope of the present disclosure.

In one example, in a scenario where the set of training data is unlabeled, the set of output data 110 may include, for each data object in the set of training data 102, a probability distribution determining a probability that the data object is a value within a range of observed values. In one particular example of this scenario, the set of training data 102 may include images of human hands positioned in different orientations. The set of output data 110 of the global machine-learning classifier 108 may include, for each image, a probability distribution indicating different angles of rotation of the human hand in the image. In particular, the probability distribution may include a plurality of different observed angles of rotation in a range of rotation that act as different buckets or classes. Further, the probability distribution may include for each bucket, a probability that the angle of rotation of the human hand in the image corresponds to the bucket. In one example, the range of rotation may be determined based on observed examples in the set of training data 102. In another example, the range of rotation may be predetermined. In another example, the range of rotation may be determined in another manner.

The set of training data may be partitioned into a plurality of subsets based on the set of output data 110 to produce a partitioned set of training data 112. Each subset may correspond to a different class. The set of training data may be partitioned in any suitable manner. In one example, the set of training data may be partitioned into a learned number of subsets that is determined based on the set of output data produced by the global machine-learning classifier. For example, the learned number of subsets may be determined by applying a K-means clustering algorithm to the set of output data 110. In particular, the set of output data 110 may be divided into K clusters or subsets each having a prototype data object representing the cluster, and each output data object may be assigned to a cluster having a prototype data object with a nearest mean to the output data object. In one example, the number of subsets may be determined so as to minimize a within-cluster sum of squares calculation. The number of subsets in which the set of training data may be partitioned may be learned in any suitable manner.

In another example, the set of output data 110 of the global machine-learning classifier 108 may include one or more decision trees. The set of training data may be partitioned or clustered into subsets based on similarities of leaf nodes of the one or more decision trees. Further, the set of training data may be partitioned into subsets based on other data associated with leaf nodes of the one or more decision trees. For example, training data objects that produce output data having similar probability distributions/histograms may be grouped together in the same subset.

In another example, the set of training data may be partitioned into subsets based on the global machine-learning classifier being confused or not being able to make a distinction between two or more classifications. For example, when multiple similar training data objects confuse the global machine-learning classifier, a subset may be created to group these training data objects. Further, in some implementations, a subset-specific machine-learning classifier may be trained on just the subset of training data to provide more accurate classification of the training data objects that the global machine-learning classifier was unable to classify.

In some implementations where the set of training data 102 is labeled prior to being used to train the global machine-learning classifier, the set of training data may be classified into a first plurality of subsets corresponding to a first plurality of classes. Further, when the set of training data 102 is partitioned based on the set of output data 110 produced by the global machine-learning classifier 108, the set of training data 102 may be re-classified into a second plurality of subsets different than the first plurality of subsets. Moreover, the second plurality of subsets may correspond to a second plurality of classes different than the first plurality of classes.

In the illustrated example, the plurality of predetermined subsets are indicated by the dotted lines, and the new subsets are indicated by the dashed lines. As one example, the subset 106 includes a plurality of data objects of the set of training data 102 that are classified as belonging to a predetermined class, and a subset 114 includes a plurality of data object of the set of training data 102 that are classified as belonging to a learned class.

In some implementations, a training data object may belong to more than one subset or class. In other implementations, there may be no overlap of training data between different subsets or classes. In other words, each training data object may belong to only one subset or class.

In one example, one or more subsets of the plurality of learned subsets may be determined based on the set of output data 110 produced by the global machine-learning classifier 108 including, for a number of data objects of the set of training data 102 greater than a confusion threshold, a probability distribution indicating that the first machine-learning classifier is not able to distinguish between two or more classes of the first plurality of classes. The confusion threshold may correspond to any suitable number of data objects. For example, the confusion threshold may include a percentage of data objects relative to a total number of data objects in the set of training data (e.g., 5%). In another example, the confusion threshold may be set to a predetermine number of data objects (e.g., 100).

In one particular example, returning to the hand pose scenario, a ground truth of images of different hand poses may be labeled with predetermined classes (e.g., open, closed, pointing). However, the global machine-learning classifier for some images may be unable to distinguish between classes to which the image belongs. Accordingly, additional subsets may be created that group images that confuse the global machine-learning classifier. In other words, the ground truth may be reclassified into different subsets. Furthermore, additional subset-specific classifiers may be trained on just the subsets of training data to more accurately classify images relative to the single global machine-learning classifier.

Once the set of training data is partitioned into a plurality of subsets corresponding to different classes, a partitioned machine-learning classifier 112 may be trained on the partitioned set of training data 112 using the plurality of classes corresponding to the plurality of learned subsets to produce a set of output data 118. In one example, the output data 118 may include for each data object of the set of training data, a probability distribution having for each learned class a probability that the data object is a member of the learned class.

Once the partitioned machine-learning classifier 116 is trained, the classifier may be run on various real-world data to classify the real-world data according to the plurality of learned classes. The partitioned machine-learning classifier 116 may provide more accurate classification of real-world data relative to the global machine-learning classifier 108, because the learned classes may more accurately capture a problem space occupied by the set of training data relative to predetermined classes that may not include classes for all training data objects in the set of training data.

Furthermore, in scenarios where subsets are created based on the global machine-learning classifier being confused between two or more different classes, additional subset-specific machine-learning classifiers may be trained on a particular subset of training data. Further, the partitioned machine-learning classifier 116 may be chained together with the subset-specific machine-learning classifiers to form a hierarchy of machine-learning classifiers. Within the hierarchy of classifiers, the global machine-learning classifier may direct real-world data that the global machine-learning classifier is unable to distinguish to a selected subset-specific machine-learning classifier in order to accurately classify the real-world data.

In some implementations, a subset-specific machine-learning classifier may be trained on each learned subset created by the partitioning of the set of training data. In other implementations, subset-specific machine-learning classifiers may be trained for selected subsets. For example, subset-specific machine-learning classifiers may be trained only on selected subsets of training data that indicate confusion of the global machine-learning classifier (e.g., the number of data objects in the subset is greater than a confusion threshold).

In some implementations, a number of subset-specific machine-learning classifiers may be determined based on available resources in a computing system that implements the hierarchy of classifiers. For example, a computing system with limited resources may only implement a two-level hierarchy of classifiers. In another example, a computing system with greater resources may implement a hierarchy of classifiers having three or more levels. A hierarchy of classifiers may include any suitable number of levels.

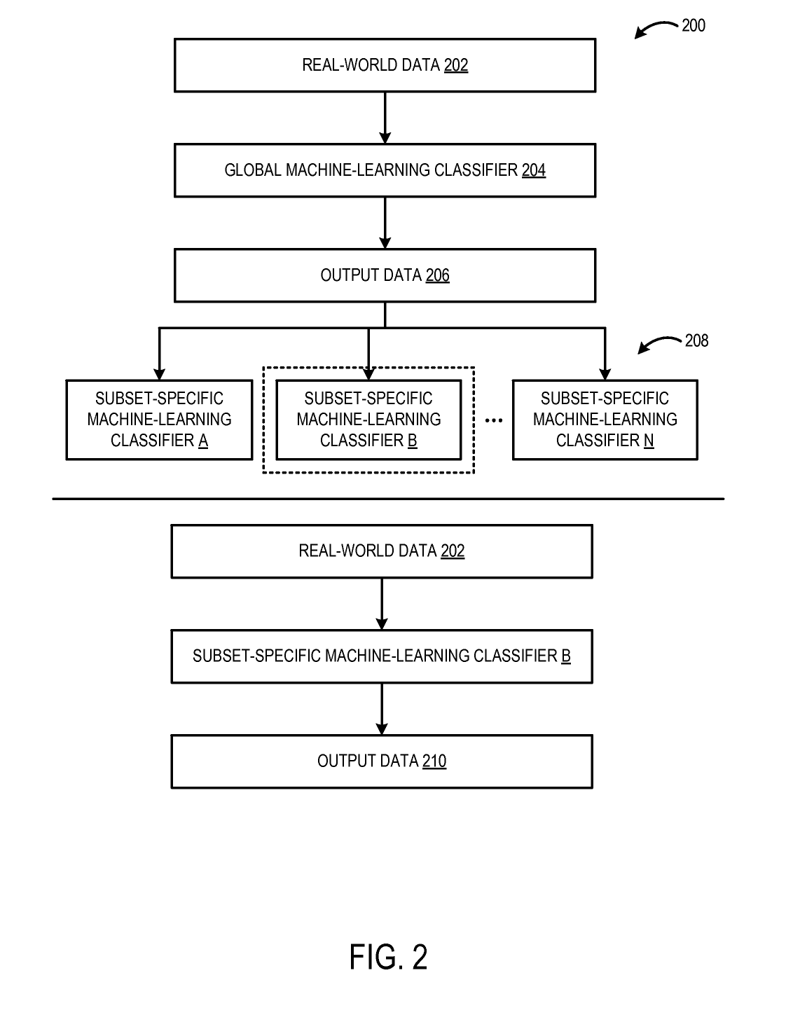

FIG. 2 shows an example approach for classifying real-world data using a hierarchy of machine-learning classifiers 200. For example, the approach may be performed by a computing system, such as the computing system 900 shown in FIG. 9.

In the illustrated example, the hierarchy of machine-learning classifiers 200 is a two-level hierarchy including a global machine-learning classifier 204 and a plurality of subset-specific machine-learning classifiers (e.g., CLASSIFIER A, CLASSIFIER B, . . . , and CLASSIFIER N) 208. In one example, the global machine-learning classifier 204 may be trained on an entire set of training data, such as according to the approach 100 shown in FIG. 1. Further, the plurality of subset-specific machine-learning classifiers 208 may be trained on different subsets of the set of training data.

At run-time, the real-world data 202 to be classified may be input to the global machine-learning classifier 204. The global machine-learning classifier 204 may produce output data 206 that may be analyzed to select a subset-specific machine-learning classifier from the plurality of subset-specific machine-learning classifiers 208 to be run on the real-world data 202 in order to provide more accurate classification.

In some cases, the global machine-learning classifier 204 may accurately classify the real-world data 202, and the real-world data 202 may not be processed by a lower-level learning classifier in the hierarchy of machine-learning classifiers 200. In other cases, the global machine-learning classifier 204 may be confused or otherwise may be unable to accurately classify the real-world data 202. As such, the real-world data 202 may be routed to a lower-level machine-learning classifier for more accurate classification.

In one example, the output data 206 may indicate that the global machine-learning classifier 204 is unable to accurately distinguish whether the real-world data 202 is a member of two classes (e.g., a probability distribution indicates that the two classes have an equally highest probability that the real-world data is a member of the class). As such, a subset-specific machine-learning classifier that is trained on a subset of training data that resembles or otherwise corresponds to an overlap of the two classes in question may be selected to process the real-word data 202.

In the illustrated example, the subset-specific machine-learning classifier B is selected based on the output data 206 produced by the global machine-learning classifier 204. Further, the real-world data 202 is input to the subset-specific machine-learning classifier B to produce output data 210. The output data 210 indicates a class to which the real-world data is a member. For example, the output data 210 may include a probability distribution having for each class a probability that the real-world data is a member of the class, and the class having the highest probability may be assigned to the real-word data. Accordingly, the real-world data may be accurately classified even when the global machine-learning classifier is confused by the real-world data.

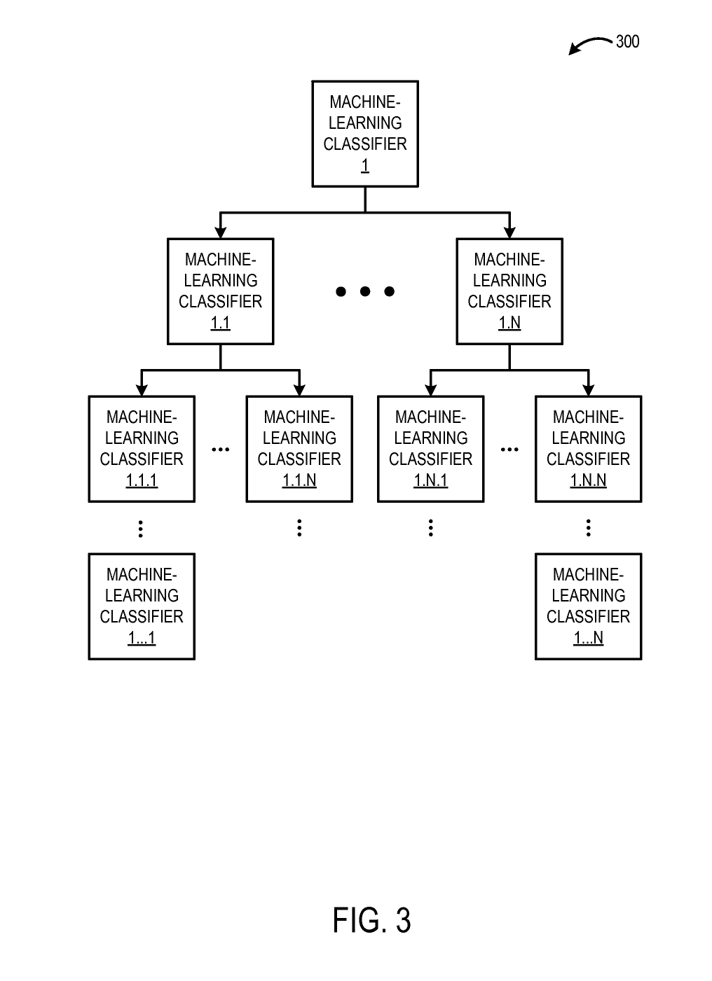

FIG. 3 shows an example hierarchy 300 of machine-learning classifiers. The hierarchy 300 is organized in a tree format having different levels of machine-learning classifiers. The machine-learning classifiers on each level may narrow in specialization moving down the branches of the tree. A machine-learning classifier 1 acts as a root node in the tree. In particular, data to be classified may be input to the machine-learning classifier 1 to produce output data. If the output data indicates an accurate classification of the data, then a class may be assigned to the data. Otherwise, a more specialized machine-learning classifier (e.g., machine-learning classifier 1.1, machine-learning classifier 1.N) in the next level of the tree may be selected to be run on the data to be classified based on the output data produced by the machine-learning classifier 1. The classification process may be repeated moving lower down the tree until an accurate classification of the data is achieved.

A hierarchy of machine-learning classifiers may include any suitable number of machine-learning classifiers organized into any suitable number of levels of specialization. Moreover, a hierarchy of machine-learning classifiers may be organized into formats other than a tree without departing from the scope of the present disclosure.

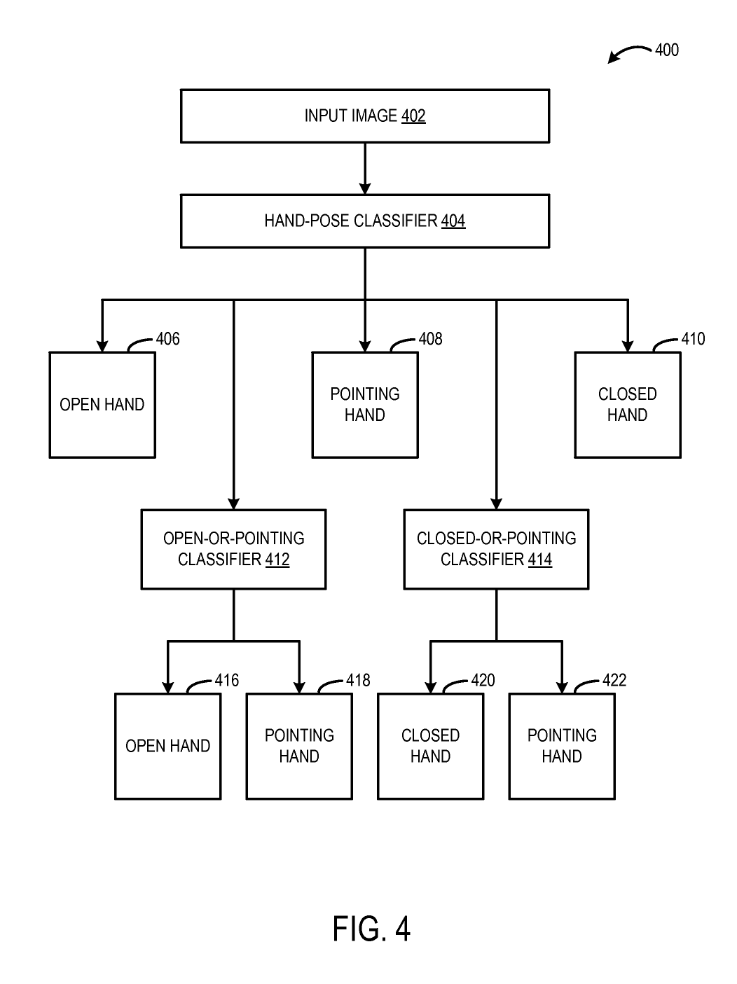

FIG. 4 shows an example hierarchy 400 of machine-learning classifiers configured to classify images of different hand poses. The hierarchy 400 includes a hand-pose classifier 404 that may be trained on a set of hand-pose images. The hand-pose classifier 404 may be configured classify an input image 402 of a hand as one of three different classes including an open hand 406, a pointing hand 408, and a closed hand 410. In particular, the hand-pose classifier 404 may produce output data including a probability distribution having for each class, a probability that the input image 402 is a member of the class.

In some cases, the hand-pose classifier 404 may be unable to distinguish whether a hand in the input image 402 is open or pointing. For example, the probability distribution may indicate that a probability corresponding to the open hand class and a probability corresponding to the pointing hand class are similar and more likely than a probability corresponding to the closed hand class. Further, in some cases, the hand-pose classifier 404 may be unable to distinguish whether a hand in an input image is closed or pointing. For example, the probability distribution may indicate that a probability corresponding to the closed hand class and a probability corresponding to the pointing hand class are similar and more likely than a probability corresponding to the open hand class. The hand-pose classifier 404 may be unable to classify the hand pose in such cases, because the classifier may be broadly trained on the entire set of hand-pose images.

Accordingly, to accurately classify images where the hand-pose classifier 404 is confused, the hierarchy 400 includes an open-or-pointing classifier 412 and a closed-or-pointing classifier 414 that may be trained to handle these specific scenarios. In response to the hand-pose classifier 404 being unable to distinguish between an open hand and a pointing hand, the image data is routed to the open-or-pointing classifier 412. In response to the hand-pose classifier 404 being unable to distinguish between a closed hand and a pointing hand, the image data is routed to the closed-or-pointing classifier 414.

The open-or-pointing classifier 412 may be trained on a subset of hand-pose images in which the hand-pose classifier is unable to distinguish whether a hand is open or pointing. Because the open-or-pointing classifier 412 is trained on just this subset of hand-pose images, the open-or-pointing classifier 412 may have more specialized training that allows open-or-pointing classifier to classify a hand-pose image in question as being an open hand or a pointing hand. In response to a probability distribution produced by the open-or-pointing classifier 412 indicating that the input image 402 is a member of the open hand class, an open hand class label 416 may be assigned to the input image 402. In response to the probability distribution produced by the open-or-pointing classifier 412 indicating that the input image 402 is a member of the pointing hand class, a pointing hand class label 418 may be assigned to the input image 402.

The closed-or-pointing classifier 414 may be trained on a subset of hand-pose images in which the hand-pose classifier is unable to distinguish whether a hand is closed or pointing. Because the closed-or-pointing classifier 414 is trained on just this subset of hand-pose images, the closed-or-pointing classifier 414 may have more specialized training that allows the closed-or-pointing classifier to classify a hand-pose image in question as being a closed hand or a pointing hand. In response to a probability distribution produced by the closed-or-pointing classifier 414 indicating that the input image 402 is a member of the closed hand class, a closed hand class label 420 may be assigned to the input image 402. In response to the probability distribution produced by the closed-or-pointing classifier 414 indicating that the input image 402 is a member of the pointing hand class, a pointing hand class label 422 may be assigned to the input image 402.

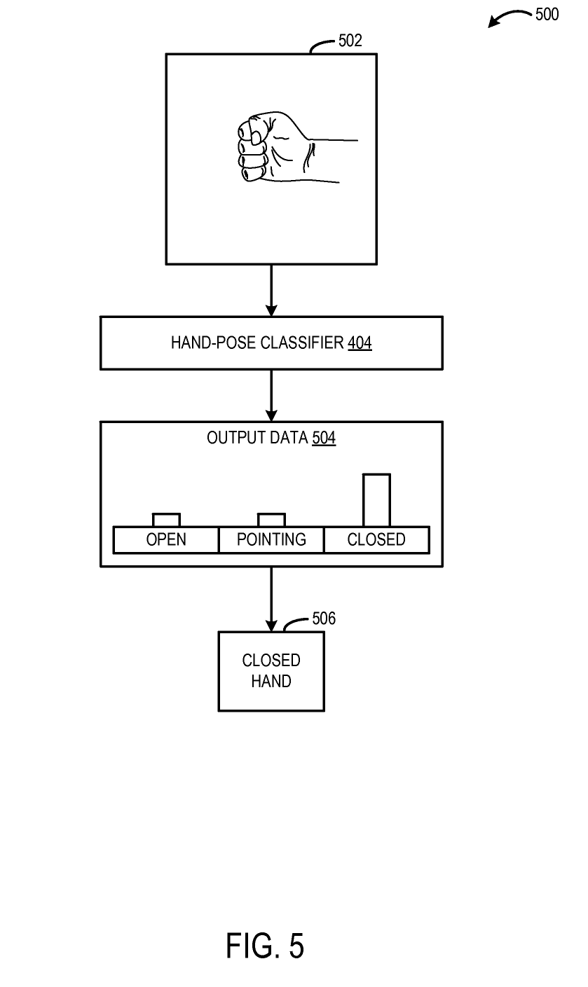

FIG. 5 shows an example scenario 500 in which a hand-pose image 502 is classified by the hierarchy 400 of machine-learning classifiers shown in FIG. 4 as being a closed hand. In particular, the hand-pose image 502 may be input to the hand-pose classifier 404. The hand-pose classifier 404 may produce output data 504 including a probability distribution having for each of the open class, the pointing class, and the closed class, a probability that the hand-pose image 502 is a member of the class. In this example, the probability distribution indicates that the hand-pose image 502 is a member of the closed hand class, and the closed hand class label 506 is assigned to the hand-pose image 502. In this scenario, the hand-pose classifier is able to accurately classify the hand-pose image without moving to a second level of the hierarchy.

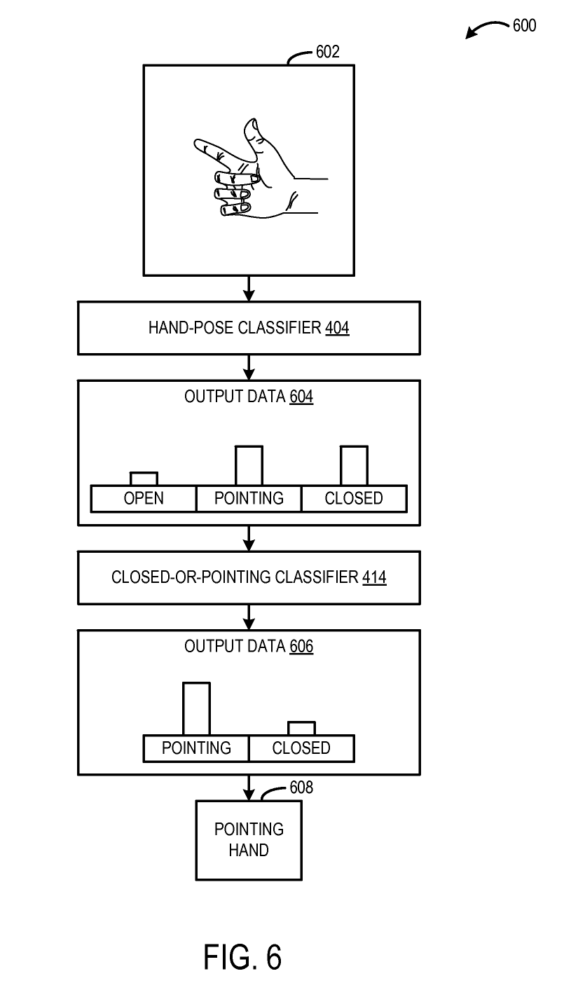

FIG. 6 shows an example scenario 600 in which a hand-pose image 602 is classified by the hierarchy 400 of machine-learning classifiers shown in FIG. 4 as being a pointing hand. In particular, the hand-pose image 602 may be input to the hand-pose classifier 404. The hand-pose classifier 404 may produce output data 604 including a probability distribution having for each of the open class, the pointing class, and the closed class, a probability that the hand-pose image 502 is a member of the class. In this example, the probability distribution of the hand-pose classifier 404 indicates that the hand-pose image 502 is a member of the pointing hand class and the closed hand class. In other words, the hand-pose classifier 404 is confused. Accordingly, the closed-or-pointing classifier 414 is selected to be run on the hand-pose image 602. The closed-or-pointing classifier 414 produces output data 606 including a probability distribution indicating that the hand-pose image 602 is a member of the pointing class, and the pointing hand class label 608 is assigned to the hand-pose image 602. In this scenario, the hand-pose classifier is unable to accurately classify the hand-pose image, and the hand-pose image is routed to a more specialized classifier in the hierarchy 400 in order to accurately classify the hand-pose image.

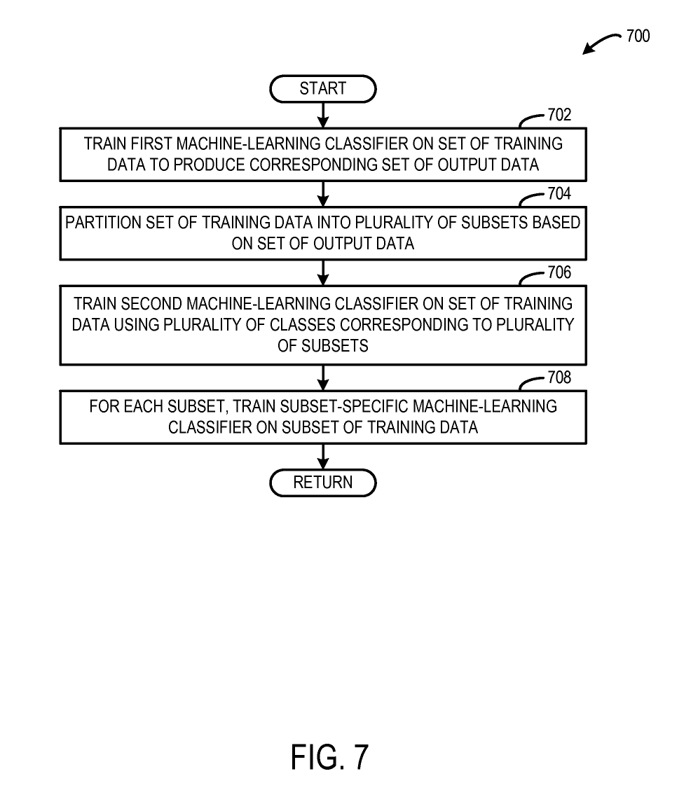

FIG. 7 shows an example method 700 for training machine-learning classifiers on a set of training data having learned partitions. For example, the method 700 may be performed by the computing system 900 shown in FIG. 9.

At 702, the method 700 may include training a first machine-learning classifier on a set of training data to produce a corresponding set of output data. In one example, the output data may include, for each data object in the set of training data, a probability distribution determining a probability that the data object is a value within a range of observed values. In another example, the output data may include, for each data object in the set of training data, a probability distribution having for each of a plurality of predefined classes a probability that the data object is a member of the class.

At 704, the method 700 may include partitioning the set of training data into a plurality of subsets based on the set of output data produced by the first machine-learning classifier. The set of training data may be partitioned based on the output data in any suitable manner. For example, the set of training data may be partitioned by applying a K-means clustering algorithm to the set of output data. In another example, where the output data of the first machine-learning classifier includes one or more decision trees, the set of training data may be partitioned based on similarities of leaf nodes of the one or more decision trees.

When the set of training data is partitioned into the plurality of subsets, each subset may correspond to a different class. In some implementations, if the set of training data is unlabeled prior to training the first machine-learning classifier, then the plurality of different classes may be assigned to the set training data. In some implementations, if the set of training data is labeled with a first plurality of classes corresponding to a first plurality of subsets prior to training the first machine-learning classifier, then the set of training data may be re-classified into a second plurality of subsets different than the first plurality of subsets. Further, the second plurality of subsets may correspond to a second plurality of classes different than the first plurality of classes.

At 706, the method 700 may include training a second machine-learning classifier on the set of training data using a plurality of classes corresponding to the plurality of subsets to produce, for each data object of the set of training data, a probability distribution having for each class a probability that the data object is a member of the class.

At 708, optionally the method 700 may include for each subset, training a subset-specific machine-learning classifier on the subset of the training data to produce, for each data object of the subset, a probability distribution having for each class a probability that the data object is a member of the class. The second machine-learning classifier and the subset-specific machine-learning classifiers may be chained together in a hierarchy of machine-learning classifiers.

By partitioning the set of training data in a learned manner that is based on output data from a globally trained machine-learning classifier, classes may be generated that correspond to learned subsets that suitably cover a problem space occupied by the set of training data. Such learned classifiers may provide more accurate classification of the set of training data relative to a plurality of predefined classes that are not tailored to the set of training data.

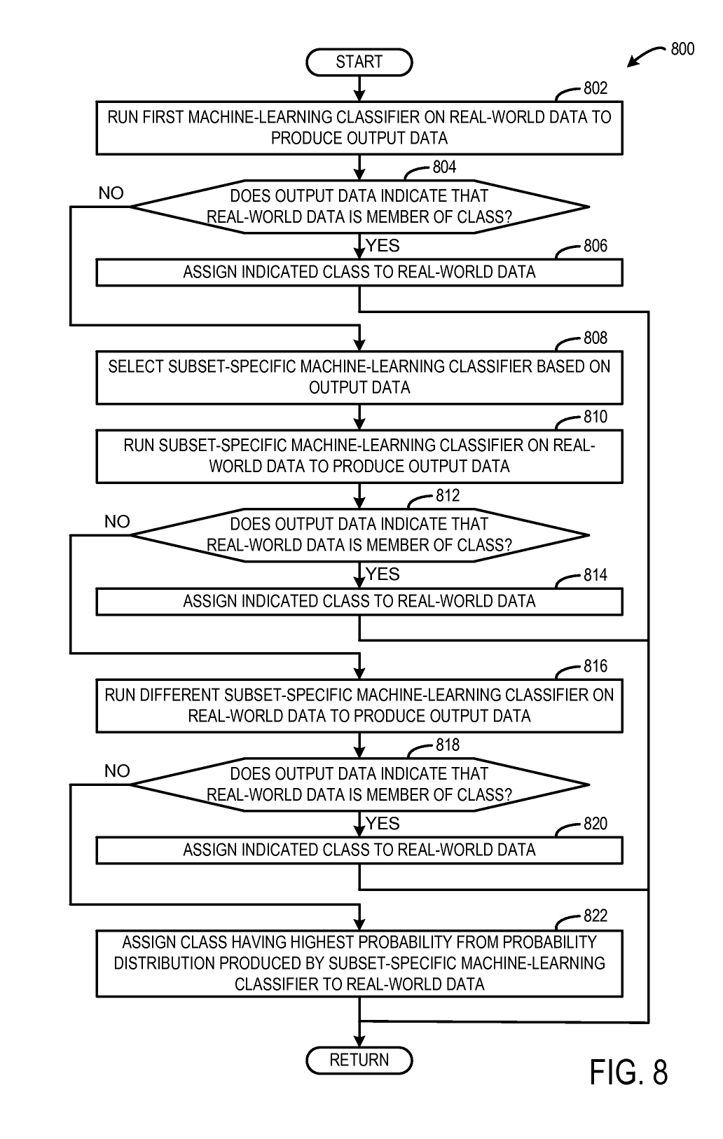

FIG. 8 shows an example method 800 for classifying real-world data using a hierarchy of classifiers. For example, the method 800 may be performed by the computing system 900 shown in FIG. 9.

At 802, the method 800 may include running a first machine-learning classifier on real-world data to produce output data. The first machine-learning classifier may be trained on an entire set of training data that is partitioned into a plurality of learned subsets based on output data from a machine-learning classifier. For example, the output data may include a probability distribution having for each learned class a probability that the real-world data is a member of the class.

At 804, the method 800 may include determining whether the output data produced by the first machine-learning classifier indicates that the real-world data is a member of a class. In one example, a class having a highest probability may indicate that the real-world data is a member of the class. In another example, a class having a highest probability and being at least five percent (or another suitable percentage) greater than a next highest probability of another class in the probability distribution may indicate that the real-world data is a member of the class. The real-world data may be determined to be a member of a class based on the output data in any suitable manner. If the output data indicates that the real-world data is a member of a class, then the method 800 moves to 806. Otherwise, the first machine-learning classifier is not able to distinguish between two or more classes, and the method moves to 808.

At 806, the method 800 may include assigning the class identified by the first machine-learning classifier to the real-world data, and returning to other operations.

At 808, the method 800 may include selecting a subset-specific machine-learning classifier based on the output data produced by the first machine-learning classifier. For example, the selected subset-specific machine-learning classifier may be one of a plurality of subset-specific machine-learning classifiers train on different subsets of the set of training data.

In one example, in response to the output data of the first machine-learning classifier indicating that the first machine-learning classifier is not able to distinguish between two classes, a subset-specific machine-learning classifier that is trained on a subset including data objects that resemble or otherwise correspond to the two classes may be selected.

At 810, the method 800 may include running the subset-specific machine-learning classifier on the real-world data to produce output data.

At 812, the method 800 may include determining whether the output data produced by the subset-specific machine learning classifier indicates that the real-world data is a member of a class. If the output data indicates that the real-world data is a member of a class, then the method 800 moves to 814. Otherwise, the method 800 moves to 816.

At 814, the method 800 may include assigning the class identified by the subset-specific machine-learning classifier to the real-world data, and returning to other operations.

At 816, the method 800 may include running the real-world data on a different subset-specific machine-learning classifier trained on a different (e.g., smaller) subset of the training data to produce output data. For example, the different subset-specific machine-learning classifier may be a classifier that is lower in the hierarchy of classifiers. In one example, the different subset-specific machine-learning classifier is a child classifier of the subset-specific machine-learning classifier in a tree of classifiers. In one example, the different subset-specific machine-learning classifier may be trained on a subset of the training data including the two or more classes that the subset-specific machine-learning classifier was unable to distinguish. The different subset-specific machine learning classifier may be selected in any suitable manner. For example, the different subset-specific machine learning classifier may be selected based on the output data of the subset-specific machine-learning classifier.

At 818, the method 800 may include determining whether the output data produced by the different subset-specific machine learning classifier indicates that the real-world data is a member of a class. If the output data indicates that the real-world data is a member of a class, then the method 800 moves to 820. Otherwise, the method 800 moves to 822.

At 820, the method 800 may include assigning the class identified by the different subset-specific machine-learning classifier to the real-world data, and returning to other operations.

If the different subset-specific machine-learning classifier is not able to distinguish between two or more classes then, at 822, the method 800 may include assigning a class having a highest probability from a probability distribution produced by the different subset-specific machine-learning classifier, and returning to other operations.

In some implementations, the hierarchy of machine-learning classifiers may include more than three levels of classifiers, and the real-world data may be passed further down the hierarchy until the real-world data can be distinguished as belonging to a particular class.

By organizing machine-learning classifiers that are trained to identify specific scenarios into a hierarchy, real-world data to be classified may be directed to an appropriate machine-learning classifier that is trained to identify the particular scenario for the data. As such, real-world data may be classified in an accurate manner.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system comprising:
a logic machine;
a storage machine holding instructions executable by the logic machine to:
train a first machine-learning classifier on a set of training data to produce a corresponding set of output data;
partition the set of training data into a plurality of subsets based on the set of output data, each subset corresponding to a different class; and
train a second machine-learning classifier on the set of training data using a plurality of classes corresponding to the plurality of subsets to produce, for each data object of the set of training data, a probability distribution having for each class a probability that the data object is a member of the class.

2. The computing system of claim 1, where the set of training data is unlabeled prior to being used to train the first machine-learning classifier, and the set of output data produced by the first machine-learning classifier includes, for each data object of the set of training data, a probability distribution determining a probability that the data object is a value within a range of observed values.

3. The computing system of claim 1, where the set of training data is labeled prior to being used to train the first machine-learning classifier such that the set of training data is classified into a first plurality of subsets corresponding to a first plurality of classes, and where the set of training data is partitioned based on the set of output data produced by the first machine-learning classifier to re-classify the set of training data into a second plurality of subsets different than the first plurality of subsets, the second plurality of subsets corresponding to a second plurality of classes different than the first plurality of classes.

4. The computing system of claim 3, where one or more subsets of the second plurality of subsets are determined based on the set of output data produced by the first machine-learning classifier including, for a number of data objects of the set of training data greater than a confusion threshold, a probability distribution indicating that the first machine-learning classifier is not able to distinguish between two or more classes of the first plurality of classes.

5. The computing system of claim 1, where the set of training data is partitioned into a learned number of subsets that is determined based on the set of output data produced by the first machine-learning classifier.

6. The computing system of claim 1, where the plurality of subsets are determined by applying a K-means clustering algorithm to the set of output data.

7. The computing system of claim 1, where the output data of the first machine-learning classifier includes one or more decision trees, and where the plurality of subsets are determined based on similarities of leaf nodes of the one or more decision trees.

8. The computing system of claim 1, where the storage machine further holds instructions executable by the logic machine to:
for each subset, train a subset-specific machine-learning classifier on the subset of the training data to produce, for each data object of the subset, a probability distribution having for each class a probability that the data object is a member of the class.

9. The computing system of claim 1, where the storage machine further holds instructions executable by the logic machine to:
receive real-world data to be classified;
run the second machine-learning classifier on the real-world data to produce output data including a probability distribution having for each class a probability that the real-world data is a member of the class; and
in response to the probability distribution indicating that the second machine-learning classifier is not able to distinguish between two or more classes, run the subset-specific machine-learning classifiers of the subsets corresponding to the two or more classes on the real-world data to produce output data including a probability distribution having for each class a probability that the real-world data is a member of the class.

10. The computing system of claim 9, where the storage machine further holds instructions executable by the logic machine to:
in response to the probability distribution produced by the second machine-learning classifier indicating that the real-world data is a member of a class, assign the class to the real-world data; and
in response to the probability distribution produced by the subset-specific machine-learning classifier indicating that the real-world data is a member of a class, assign the class to the real-world data.

11. A computing system comprising:
a logic machine;
a storage machine holding instructions executable by the logic machine to:
receive real-world data to be classified;
run a first machine-learning classifier on the real-world data to produce output data, the first machine-learning classifier being trained on a set of training data partitioned into a plurality of subsets corresponding to a plurality of classes, the output data including a probability distribution having for each class a probability that the real-world data is a member of the class;
select a subset-specific machine-learning classifier based on the output data produced by the first machine-learning classifier, the subset-specific machine-learning classifier being trained on a subset of the set of training data; and
run the subset-specific machine-learning classifier on the real-world data to produce output data including a probability distribution having for each class a probability that the real-world data is a member of the class.

12. The computing system of claim 11, where the storage machine further holds instructions executable by the logic machine to:
in response to the probability distribution produced by the first machine-learning classifier indicating that the real-world data is a member of a class, assign the class to the real-world data; and
in response to the probability distribution produced by the subset-specific machine-learning classifier indicating that the real-world data is a member of a class, assign the class to the real-world data.

13. The computing system of claim 11, where the subset-specific machine-learning classifier is selected from a plurality of subset-specific machine-learning classifiers based on the output data produced by the first machine-learning classifier, and where each of the plurality of subset-specific machine-learning classifiers are trained on a different subset of the plurality of subsets.

14. The computing system of claim 11, where the subset-specific machine-learning classifier is selected based on the probability distribution indicating that the first machine-learning classifier is not able to distinguish between two or more classes.

15. The computing system of claim 11, where the set of training data is partitioned into a learned number of subsets that is determined based on a set of output data produced by a machine-learning classifier.

16. The computing system of claim 15, where the plurality of subsets are determined by applying a K-means clustering algorithm to the set of output data.

17. The computing system of claim 11, where the output data of the first machine-learning classifier includes one or more decision trees, and where the plurality of partitions are determined based on similarities of leaf nodes of the one or more decision trees.

18. A method for classifying data comprising:
receiving real-world data to be classified;
running a first machine-learning classifier on the real-world data to produce output data, the first machine-learning classifier being trained on a set of training data partitioned into a plurality of subsets corresponding to a plurality of classes, the output data including a first probability distribution having for each class a probability that the real-world data is a member of the class;
in response to the first probability distribution indicating that the first machine-learning classifier is not able to distinguish between two or more classes, select a subset-specific machine-learning classifier trained on a subset of training data that corresponds to the two or more classes; and
run the subset-specific machine-learning classifier on the real-world data to produce output data including a second probability distribution having for each class a probability that the real-world data is a member of the class.

19. The method of claim 18, further comprising:
in response to the first probability distribution produced by the first machine-learning classifier indicating that the real-world data is a member of a class, assigning the class to the real-world data; and
in response to the second probability distribution produced by the subset-specific machine-learning classifier indicating that the real-world data is a member of a class, assigning the class to the real-world data.

20. The method of claim 18, further comprising:
in response to the second probability distribution indicating that the subset-specific machine-learning classifier is not able to distinguish between two or more classes, select a different subset-specific machine-learning classifier trained on a different subset of training data that corresponds to the two or more classes;
run the different subset-specific machine-learning classifier on the real-world data to produce output data including a third probability distribution having for each class a probability that the real-world data is a member of the class; and
in response to the third probability distribution produced by the subset-specific machine-learning classifier indicating that the real-world data is a member of a class, assigning the class to the real-world data.
